(19) United States
(12) Patent Application Publication
(10) Pub. No.: US 2007/0171523 A1
(43) Pub. Date: Jul. 26, 2007

(54) Wide angle film unit, projection screen and display apparatus comprising the film unit

(75) Inventor: Seok-il Yoon, Daejeon (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/650,969

(22) Filed: Jan. 9, 2007

(30) Foreign Application Priority Data
Jan. 25, 2006 (KR) 10-2006-0007988

(51) Int. Cl. G03B 21/60

(52) U.S. Cl. 359/455

(57) ABSTRACT

A projection screen and a projection display apparatus include a film unit. The projection screen includes a total reflection prism lens having a plurality of total reflection prism unit lenses formed on the rear surface on which imaging light is incident; and a lenticular lens installed close to the total reflection prism lens, and having a plurality of lenticular unit lenses for spreading an incident light from the total reflection prism lens. Each of the plurality of lenticular unit lenses has a trapezoidal shape in a horizontal cross-section and vertical cross-section. The projection screen has wide view angles in both horizontal and vertical directions, and an improved contrast ratio for external light.

### CROSS-REFERENCE TO RELATED APPLICATION

This application claims the benefit under 35 U.S.C. § 119 from Korean Patent Application No. 2006-7988, filed Jan. 25, 2006, the entire content of which is hereby incorporated by reference.

### BACKGROUND OF THE INVENTION

1. Field of the Invention

The present invention relates in general to a wide angle film unit, and a projection screen and a display apparatus comprising the film unit. More specifically, the present invention relates to a film unit having wide view angles in the horizontal and vertical directions. The invention is also directed to a projection screen and a projection display comprising the wide angle film unit.

2. Description of the Related Art

A projection display apparatus such as a projection television uses an imaging light source usually of red, green and blue color lights, in which imaging light emitted from the imaging light source is projected on the rear surface of a transmission projection screen to produce an image, which is then viewed from the viewer's side. A projection screen for use in such a projection display is generally composed of a Fresnel lens and a lenticular lens. The Fresnel lens allows imaging light from an imaging light source to form an image on the projection screen, and the lenticular lens emerges the imaging light towards viewers as directional diffused light.

A typical example of such a projection display apparatus is disclosed in Korean Patent Laid-open No. 2004-90957. FIG. 1 illustrates such a projection display apparatus.

Referring to FIG. 1, the projection display apparatus 1 comprises a projection screen 10, a projection optical system 20 from which imaging light L is obliquely projected on the projection screen 10, and a reflector 30 disposed between the projection screen 10 and the projection optical system 20. The projection optical system 20 includes an imaging light source 21 composed of an LCD, DMD, or the like, and an optical system 22 for spreading the imaging light L emitted from the imaging light source 21. The projection screen 10 is for letting imaging light L, which is obliquely projected from the projection optical system 20 disposed at its rear side and reflected by the reflector 30, emerge towards the viewer's side.

FIGS. 2, 3A and 3B illustrate a detailed configuration of the projection screen 10 used in the display apparatus 1. As shown in FIG. 2, a conventional projection screen 10 comprises a total reflection prism lens (or a Fresnel lens) 12, and a lenticular lens 11 provided on the viewer's side of the total reflection prism lens 12. The total reflection prism lens 12 and the lenticular lens 11 of the projection screen 10 may be formed as a single film sheet.

Here, the total reflection prism lens 12 refracts and condenses imaging light L projected from the projection optical system 20. The total reflection prism lens 12 is formed of a plurality of unit prisms 12c, i.e., a prism array, in the shape of circular arcs extending concentrically around the center O of the concentric circles that is usually not on the screen plane. As shown in FIG. 3A, each unit prism is formed on the rear surface of the total reflection prism lens 12 on which the imaging light L is incident. Each unit prism 12c has a plane of incidence 12a that refracts incident light L, and a plane of total reflection 12b that totally reflects the light refracted from the plane of incidence 12a. Each unit prism 12c has an apical angle λ that corresponds to the angle between the plane of incidence 12a and the plane of total reflection 12b, and the apical angles λ continuously vary in a range from 30° to 45° in order to make the apical angles on the side distant from the center O of the concentric circles (the upper side in the drawing) are greater than the apical angles on the side close to the center O of the concentric circles (the lower side in the figure).

The lenticular lens 11 is formed of a plurality of cylindrical shaped unit lenses 11a on the incidence side where imaging light L is incident. The lenticular lens 11 horizontally diffuses light that has passed through the total reflection prism lens 12. The horizontal cross section of the lenticular lens 11 in the conventional projection screen 10 has a trapezoid shape. Also, a predetermined V-shaped groove array 14 is formed between unit lenses 11a of the lenticular lens 11. Since the groove array 14 is filled with a resin having a low refractive index, such as black ink, it absorbs external light generated from sunlight or fluorescent light and increases contrast ratio.

As shown in FIG. 3B, in the conventional projection screen 10 having the above-described configuration, light is totally reflected through the total reflection prism lens 12, and diffuses from the lenticular lens 11 having a high refractive index toward the groove array 14 having a low refractive index, thereby improving the horizontal view angle. However, since the projection screen 10 has a trapezoid-shaped horizontal section and a cylindrical shape in the vertical direction, the view angle is improved only in the horizontal direction, whereas hot band occurs in the vertical direction due to external light or the vertical view angle is relatively reduced.

FIG. 4 illustrates black stripes formed on the projection screen 10. Referring to FIG. 4, except for the portions on the conventional projection screen 10 where internal total reflection occurs, black ink layers are formed in the vertical direction at regular intervals. Thus, contrast ratio in the vertical direction is reduced by external light. This explains why non-uniform brightness appears in the upper, middle and lower portions of the conventional projection screen 10.

### SUMMARY OF THE INVENTION

An object of the present invention is to solve at least the above problems and/or disadvantages of the conventional projection screen. It is, therefore, an object of the present invention to provide a film unit having a wide view angle in both horizontal and vertical directions and for improving the contrast ratio for external light.

Another object of the present invention is to provide an improved projection screen comprising a film unit of the invention.

Still another object of the present invention is to provide a projection display apparatus comprising a projection screen of the invention.

To achieve the above objects and advantages, a film unit is provided, including: a base sheet; and a lenticular lens formed on one surface of the base sheet, in which the lenticular lens is comprised of a plurality of lenticular unit lenses, each unit lens having a trapezoidal cross-sectional shape in the horizontal and vertical directions.

Preferably, the plurality of lenticular unit lenses are trapezoidal unit lenses each of which base is placed on the base sheet and has an inclination angle (ρ) between the normal in the base and the inclined plane.

Here, the inclination angle of the trapezoidal lenticular unit lens is in a range of 38-42°.

The lenticular lens further includes light absorption layers formed between the plurality of lenticular unit lenses.

In addition, the lenticular lens is made of the same material as the base sheet.

Preferably, the film unit further includes: a total reflection prism lens sheet on the opposite side of the lenticular lens.

Preferably, the total reflection prism lens sheet includes a plurality of prism unit lenses, and each of the prism unit lenses comprises a plane of incidence on which imaging light is incident, and a plane of total reflection having a predetermined angle with the plane of incidence.

The prism unit lens has a triangular shaped cross section.

Also, the total reflection prism lens sheet and the lenticular lens are formed as one piece.

Another aspect of the present invention provides a film unit, including: a total reflection prism lens sheet formed of a plurality of total reflection prism unit lenses; and a lenticular lens sheet formed of a plurality of lenticular unit lenses and being in contact with the total reflection prism lens sheet, wherein each of the plurality of lenticular unit lenses has a trapezoidal shape in the horizontal cross-section and vertical cross-section.

Still another aspect of the present invention provides a projection screen, including: a total reflection prism lens having a plurality of total reflection prism unit lenses formed on the rear surface for receiving incident imaging light; and a lenticular lens installed close to the total reflection prism lens, and comprising a plurality of lenticular unit lenses for spreading an incident light from the total reflection prism lens, wherein each of the plurality of lenticular unit lenses has a trapezoidal shape in the horizontal cross-section and vertical cross-section.

Yet another aspect of the present invention provides a projection display apparatus, including: a projection screen; and a projection optical system from which imaging light is obliquely projected on the projection screen; wherein, the projection screen comprises: a total reflection prism lens having a plurality of total reflection prism unit lenses formed on the rear surface on which imaging light is incident; and a lenticular lens installed close to the total reflection prism lens, and comprising a plurality of lenticular unit lenses for spreading an incident light from the total reflection prism lens, wherein each of the plurality of lenticular unit lenses has a trapezoidal shape in the horizontal cross-section and vertical cross-section.

These and other aspects of the invention will become apparent from the annexed drawings and the detailed description of the invention which disclose various embodiments of the invention.

### BRIEF DESCRIPTION OF THE DRAWINGS

The invention will be described in detail with reference to the following drawings in which like reference numerals refer to like elements, and wherein:

FIG. 1 is a schematic view of a related prior art projection display apparatus;

FIG. 2 shows the detailed structure of a projection screen for use in the display apparatus of FIG. 1;

FIG. 3A is an enlarged perspective view of the projection screen of FIG. 2, and FIG. 3B is a cross-sectional view taken along line I-I in FIG. 3A;

FIG. 4 is a diagram showing black stripes formed on the projection screen of FIG. 2;

FIG. 5 is a schematic view of a display apparatus using a projection screen of the present invention;

FIG. 6A is a perspective view of a projection screen in FIG. 5, FIG. 6B is an X-Z cross-sectional view of FIG. 6A, and FIG. 6C is an X-Y cross-sectional view of FIG. 6A;

FIG. 7 is a diagram showing black stripes formed on a projection screen of the present invention;

FIG. 8 is a perspective view of a film unit according to the present invention; and

FIG. 9A and FIG. 9B are graphs illustrating a relation between horizontal and vertical view angles and brightness for a projection screen of the present invention.

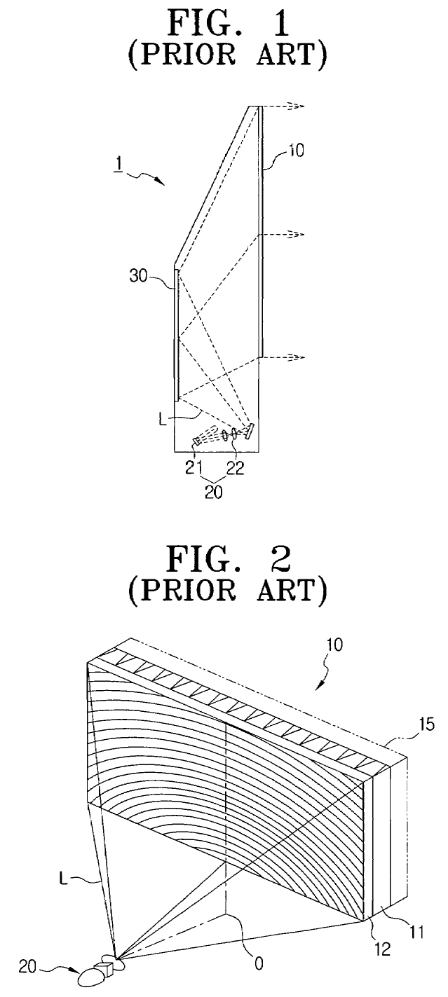

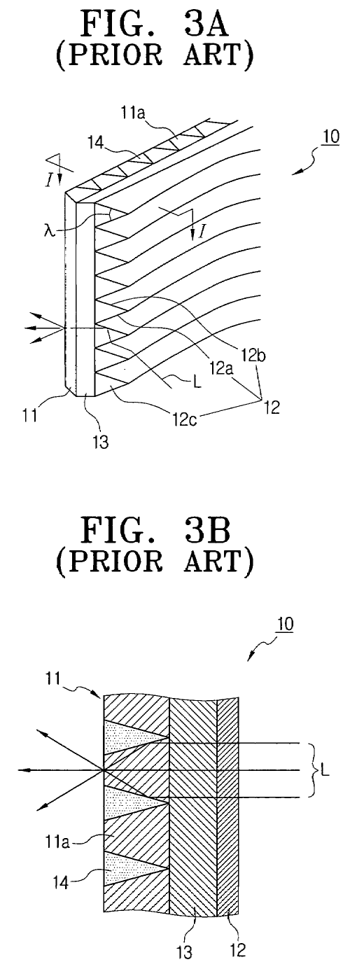

### DETAILED DESCRIPTION OF THE PREFERRED EMBODIMENTS

A film unit, a projection screen and a display apparatus of the present invention will be described herein below with reference to the accompanying drawings.

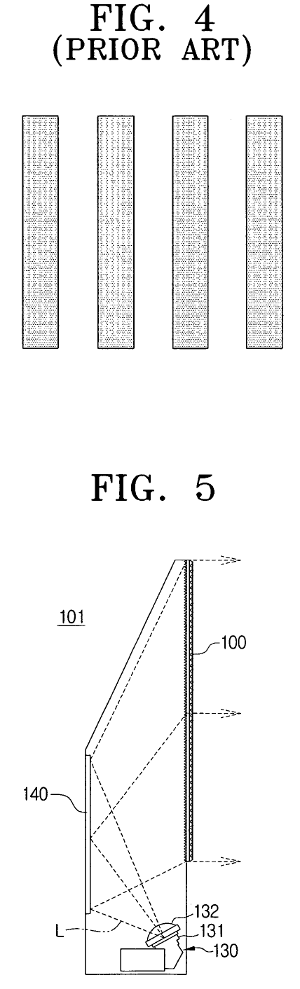

FIG. 5 is a schematic view of a display apparatus comprising a projection screen 100 of the present invention. Referring to FIG. 5, the projection display apparatus 101 includes a projection screen 100, and a projection optical system 130 from which imaging light L is obliquely projected on the projection screen 100.

The projection optical system 130 includes an imaging light source 131 composed of a cell structure such as an LCD, DMD, or the like. The projection optical system 130 may include an optical system 132 for spreading the imaging light L emitted from the imaging light source. The projection optical system 130 is disposed at the rear side of the projection screen 100, and obliquely projects the imaging light L to a reflector 140. Since this constitution is a well-known technology, details thereon will not be provided.

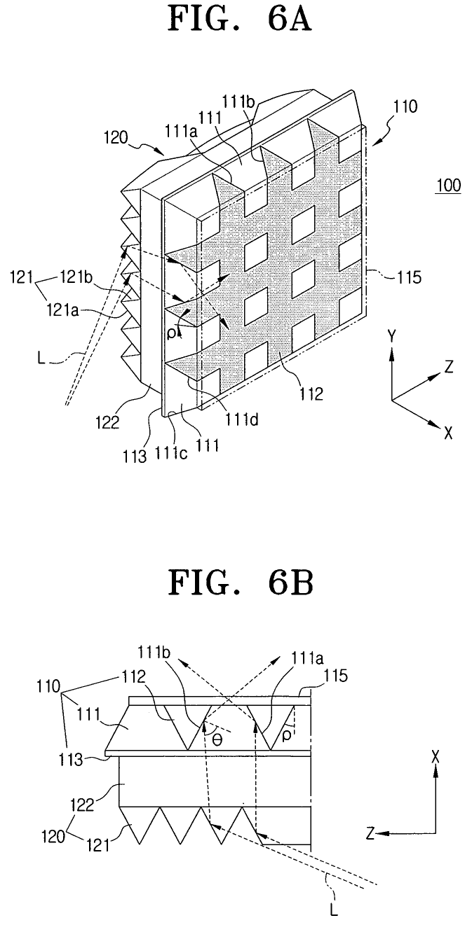

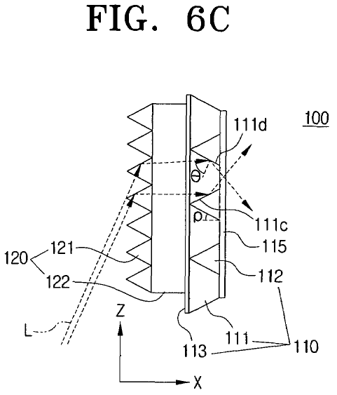

FIG. 6 illustrates the detailed structure of the projection screen 100 according to the present invention. In particular, FIG. 6A is a perspective view of the projection screen 100 of the present invention, FIG. 6B is an X-Z cross-sectional view, and FIG. 6C is an X-Y cross-sectional view.

Referring to FIG. 6, the projection screen 100 includes a lenticular lens 110 and a total reflection prism lens 120.

The lenticular lens 110 is placed on the side from which the imaging light L is emitted, being close to the total reflection prism lens 120. The lenticular lens 110 includes a plurality of unit lenses 111 for diffusing the incident imaging light L from the total reflection prism lens 120.

As depicted in FIGS. 6B and 6C, each of the lenticular unit lenses 111 has a trapezoidal shape in the horizontal and vertical cross sections. As used herein, the terms vertical and horizontal refer to the dimensions of the lenses 111 lying in the plane of the base 113 indicated by arrows Y and Z of FIG. 6A and extending perpendicular to each other. The terms horizontal and vertical correspond to the horizontal and vertical directions of the screen 100 shown in FIG. 5 as seen by the viewer. As shown in detail, referring to FIG. 6B, the plurality of lenticular unit lenses 111 form a trapezoidal lens array on the X-Z plane, expanding the horizontal angle of view. At the same time, referring to FIG. 6C, the plurality of lenticular unit lenses 111 form a trapezoidal lens array on the X-Y plane, expanding the vertical angle of view. Each trapezoidal lens has a base aligned with the base 113, a top surface parallel with the base and side surfaces that converge toward the top surface to form the trapezoidal shape in the two dimensions. As a result, the lenticular lens 110 of the present invention has the improved view angles in both horizontal and vertical directions, allowing a viewer to enjoy the optimal image quality irrespective of the position and installation angle of the projection display apparatus 101. As shown in FIGS. 6A-6C, each unit lens 111 has a trapezoidal shape in two dimensions and has the appearance of a truncated pyramid.

The horizontal and vertical view angles of the lenticular unit lens 111 vary according to the inclination angle (ρ) of a trapezoidal lens. For example, if the inclination angle (ρ) of the trapezoid in the horizontal cross-section of the lenticular unit lens 111 is greater than the inclination angle (ρ) of the trapezoid in the vertical cross-section thereof, it is not always necessary to expand the horizontal angle of view but make the vertical angle of view relatively smaller than the horizontal angle of view. It is desirable to set the horizontal and vertical view angles under the same condition.

Different from the structure of the conventional lenticular lens 11, the lenticular unit lens 111 of the present invention controls the horizontal and vertical view angles by using total internal reflection. That is, when light travels from a medium with a higher refractive index to one of a lower refractive index, if incident angles are greater than the critical angle at the boundary surface, the light stops crossing the boundary altogether and instead completely reflected back internally. The critical angle (θ) is obtained by Equation 1 as follows:

θ=arc sin(Na/Nf) [Equation 1]

Here, Nf denotes an index of screen material, and Na denotes an index of air. Although the critical angle varies slightly depending on the material of the screen, it is usually in a range of 38-420. Therefore, in order to make the lenticular unit lens 111 function as the total internal reflection lenticular lens, the critical angle (θ), i.e., the inclination angle between the normal in base and the inclined plane, should be in a range 38-42°.

Because of the total reflection lenticular lens 110 having such an angle, as shown in FIG. 6B, the imaging light L that enters normal to the lenticular lens 110 from the total reflection prism lens 120 is totally reflected internally by the planes of emission 111a and 111b of the lenticular lens 110. In this manner, the horizontal view angle of the projection screen 100 is expanded.

As illustrated in FIG. 6C, the total reflection lenticular lens 110 lets the imaging light L that is incident normal to the lenticular lens 110 is completely reflected internally from the planes of emission 111c and 111d of the lenticular lens 110. In this manner, the vertical view angle of the projection screen 100 is expanded.

The lenticular lens 110 of the present invention further includes a light absorption layer 112 formed between the plurality of lenticular unit lenses 111. As shown, the absorption layer is applied to fill the spaces completely between the lenticular unit lens 111. The absorption layer has a top surface substantially in the same plane as the top surface of the lenticular unit lens 111. The light absorption layer 112 lies between planes of total internal reflection of the lenticular unit lenses 111, and contains a light absorption resin, such as black ink. This light absorption layer 112 absorbs external light such as fluorescent light or sunlight and thus, prevents the deterioration of contrast caused by external light. That is, the deterioration of contrast caused by external light can be prevented more effectively as the black stripe ratio (B.S. ratio) gets higher.

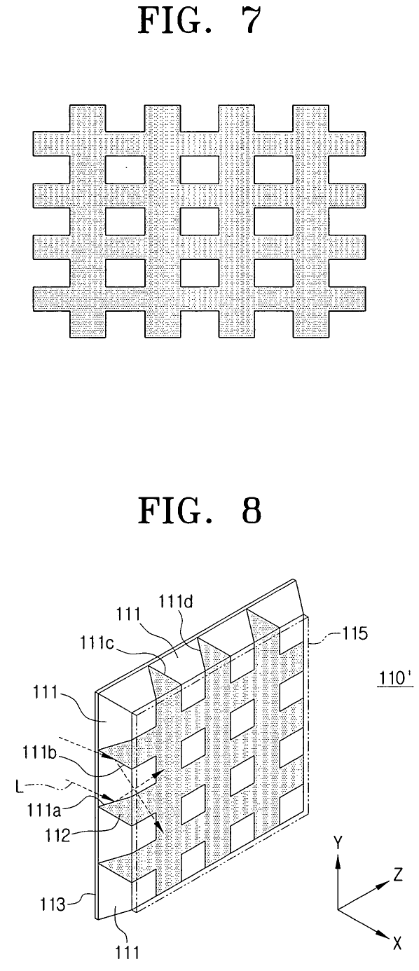

FIG. 7 illustrates a black stripe projected on the projection screen 100. Referring to FIG. 7, the projection screen 100 has black ink layers formed at regular intervals in the horizontal and vertical directions, except for a portion where total internal reflection occurs, so that it can absorb external light and improve the contrast ratio in the horizontal and vertical directions. As a result of this, brightness at the upper, middle and lower portions of the projection screen 100 appears uniform to the viewer.

The lenticular lens 110 may further include a protective layer 115 on the side of the plane of emission. As shown, the protective layer 115 overlies and contacts the outer surface of the absorption layer 112 and the outer surfaces of each lenticular unit lens 111 to form a continuous planar layer parallel to the layer 113.

The total reflection prism lens 120 has a plurality of total reflection prism unit lenses 121, and each unit prism is formed on the rear surface of the total reflection prism lens 120 on which the imaging light L is incident.

The total reflection prism unit lens 121 is composed of a plane of incidence 121a shown in FIG. 6A on which the imaging light L is directed, and a plane of total reflection 121b formed at a predetermined angle with the plane of incidence 121a. The cross-section of the total reflection prism unit lens 121 may have a triangular shape. The imaging light L from an optical system 132 is projected on the plane of incidence 121a of the total reflection prism unit lens 121 and then, is reflected totally from the plane of total reflection 121b. The totally reflected imaging light L enters almost normal to the lenticular lens 110 placed on the side of the plane of emission. As shown, the reflected imaging light L enters the lens 110 substantially perpendicular to the plane of the lens 110.

In case of this total reflection prism unit lens 121 with the above-described structure, since an angle of incidence between light from the optical system 132 incident on the screen 100 and the normal is greater than a predetermined angle, it has a considerably large index of refraction. For example, the total reflection prism unit lens 121 can be built to have a large angle of incidence between about 50° and about 80°. Therefore, the projection screen 100 of the present invention is appropriate for such a display apparatus 101, especially a slim TV.

Meanwhile, the lenticular lens 110 and total reflection prism lens 120 of the projection screen 100 can be built in one piece.

FIG. 8 illustrates a film unit 110′ corresponding to the lenticular lens 110, according to the present invention. The film unit 110′ is manufactured by forming the lenticular lens 110 including total reflection lenticular unit lenses 111 on a base sheet 113. In this case, the base sheet 113 and the lenticular lens 110 can be manufactured as one sheet. This film unit 110′ can be manufactured by hardening a film sheet in a mold with the form of the total reflection lenticular unit lens 111 having a trapezoidal cross-sectional shape in the horizontal and vertical directions.

A film unit shown in FIG. 6A can be manufactured by molding a total reflection prism lens sheet 122 formed of a plurality of total reflection prism unit lenses 121 on the plane of incidence (the left side in the drawing) of the film unit 110′. In this case, with respect to the base sheet 113, the total reflection prism lens sheet 122 formed of a plurality of total reflection prism unit lenses 121 is placed on the plane of incidence, whereas the film unit 110′ including the lenticular lens 110 formed of the total reflection lenticular unit lenses 111 is placed on the plane of emission. That is, an integral projection screen 100 can be manufactured.

The following will now describe in detail the application effect of a preferred embodiment of the present invention.

### Embodiment 1

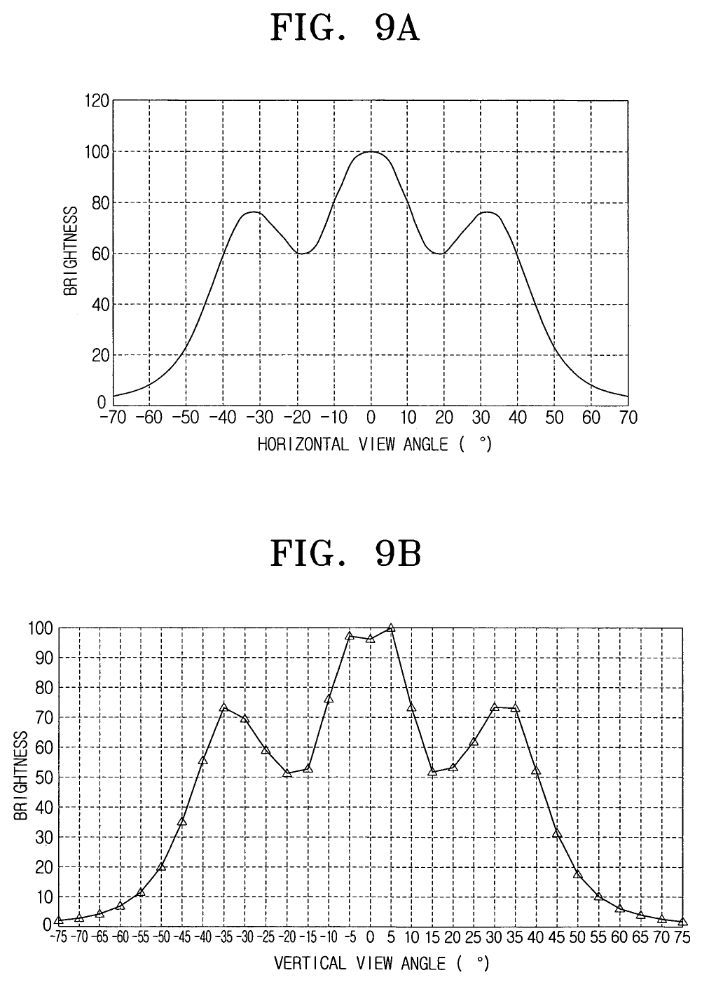

A profile of the projection screen 100 according to the present invention was studied and its result is shown in FIG. 9.

FIGS. 9A and 9B illustrate the brightness distribution of the projection screen 100 from different angles in the horizontal and vertical directions. As can be seen in the drawings, the projection screen 100 of the present invention has equally improved view angles in both horizontal and vertical directions.

### Embodiment 2

In order to compare the effect of the projection screen 100 with that of the conventional projection screen 10, a black stripe ratio formed on the screen of each was studied. Table 1 below shows the results.

TABLE 1

| Division | Total pitch | Black pitch | Lens pitch | B.S. Ratio (%) |
|---|---|---|---|---|
| Conventional | 0.065 | 0.037 | 0.028 | 57 |
| example | | | | |
| Preferred | 0.065 | 0.037 | 0.028 | 81 |
| embodiment | | | | |

As seen in the Table 1, although the projection screen 100 of the present invention has the same pitch with the conventional projection screen 10, its black stripe ratio is much higher and its contrast ratio for external light has improved.

As explained above, according to the present invention, the angle of view in the horizontal and vertical directions can be expanded by forming the total reflection prism lens array in the side of the plane of incidence of the imaging light, forming the total reflection lenticular lens in the side of the plane of emission, and designing the trapezoidal shape in the vertical cross section of the total reflection lenticular lens.

Moreover, according to the present invention, by forming the light absorption layer between the lenticular lenses, the horizontal view angle and the vertical view angle can be expanded at the same time, and the deterioration of contrast caused by the absorption of external light can be reduced.

The projection screen of the present invention is therefore appropriate for an HD projection screen and/or slim TV.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A film unit, comprising:
a base sheet; and
a lenticular lens formed on one surface of the base sheet, the lenticular lens comprising of a plurality of lenticular unit lenses, each unit lens having a trapezoidal cross-sectional shape in a horizontal and vertical direction.

2. The film unit according to claim 1, wherein the plurality of lenticular unit lenses are trapezoidal-shaped unit lenses, each having a base placed on the base sheet and having an inclination angle (ρ) between a normal in the base and an inclined plane.

3. The film unit according to claim 2, wherein the trapezoidal lenticular unit lens has an angle of inclination in a range of 38-42°.

4. The film unit according to claim 1, wherein the lenticular lens further comprises at least one light absorption layer formed between the plurality of lenticular unit lenses.

5. The film unit according to claim 1, wherein the lenticular lens is made of the same material as the base sheet.

6. The film unit according to claim 1, further comprising:
a total reflection prism lens sheet on a side opposite the lenticular lens.

7. The film unit according to claim 6, wherein the total reflection prism lens sheet comprises a plurality of prism unit lenses, each of the prism unit lenses having a plane of incidence on which imaging light is incident, and a plane of total reflection having a predetermined angle with the plane of incidence.

8. The film unit according to claim 7, wherein the prism unit lens has a triangular shaped cross section.

9. The film unit according to claim 6, wherein the total reflection prism lens sheet and the lenticular lens are formed as one piece.

10. The film unit according to claim 1, wherein the plurality of lenticular unit lenses are arranged in an array.

11. The film unit of claim 4, wherein the light absorption layer completely fills spaces between the lenticular unit lenses and has a top surface in the same plane as a top surface of each of said lenticular lenses.

12. The film unit of claim 11, wherein each of the lenticular lenses have a base, said top surface being parallel to the base and having side surfaces converging toward the top surface.

13. A film unit, comprising:
a total reflection prism lens sheet formed of a plurality of total reflection prism unit lenses; and
a lenticular lens sheet formed of a plurality of lenticular unit lenses and being in contact with the total reflection prism lens sheet, wherein each of the plurality of lenticular unit lenses has a trapezoidal shape in the horizontal cross-section and vertical cross-section.

14. The film unit according to claim 13, wherein the total reflection prism unit lens comprises a plane of incidence on which imaging light is incident, and a plane of total reflection having a predetermined angle with the plane of incidence.

15. The film unit according to claim 13, wherein the total reflection prism unit lens has a triangular shaped cross section.

16. The film unit according to claim 13, wherein the lenticular unit lens has a trapezoidal shaped cross section, and an inclination angle (ρ) between a normal in base and an inclined plane of the trapezoidal shaped cross section in a range of 38-42°.

17. The film unit according to claim 13, wherein the lenticular lens sheet further comprises at least one light absorption layer formed between the plurality of lenticular unit lenses.

18. A projection screen, comprising:
a total reflection prism lens having a plurality of total reflection prism unit lenses formed on the rear surface on which imaging light is incident; and
a lenticular lens installed close to the total reflection prism lens, and comprising a plurality of lenticular unit lenses for spreading an incident light from the total reflection prism lens, wherein each of the plurality of lenticular unit lenses has a trapezoidal shape in a horizontal cross-section and vertical cross-section.

19. The projection screen according to claim 18, wherein the total reflection prism unit lens comprises a plane of incidence on which imaging light is incident, and a plane of total reflection having a predetermined angle with the plane of incidence.

20. The projection screen according to claim 18, wherein the total reflection prism unit lens has a triangular shaped cross section.

21. The projection screen according to claim 18, wherein the lenticular unit lens has a trapezoidal shaped cross section, and an inclination angle (ρ) between the normal in base and inclined plane of the trapezoidal shaped cross section is in a range of 38-42°.

22. The projection screen according to claim 18, wherein the lenticular lens sheet further comprises at least one light absorption layer formed between the plurality of lenticular unit lenses.

23. The projection screen according claim 18, wherein the total reflection prism lens sheet and the lenticular lens are formed as one piece.

24. A projection display apparatus, comprising:
a projection screen; and
a projection optical system from which imaging light is obliquely projected on the projection screen;
wherein, the projection screen comprises:
a total reflection prism lens having a plurality of total reflection prism unit lenses formed on the rear surface on which imaging light is incident; and
a lenticular lens installed close to the total reflection prism lens, and comprising a plurality of lenticular unit lenses for spreading an incident light from the total reflection prism lens, wherein each of the plurality of lenticular unit lenses has a trapezoidal shape in a horizontal cross-section and vertical cross-section.
